(19) United States
(12) Patent Application Publication
(10) Pub. No.: US 2026/0063250 A1
(43) Pub. Date: Mar. 5, 2026

(54) LIQUID AIR ENERGY CONVERSION SYSTEM AND METHOD

(71) Applicant: Henry E. Howard, Tonawanda, NY (US)

(72) Inventor: Henry E. Howard, Tonawanda, NY (US)

(21) Appl. No.: 19/273,687

(22) Filed: Jul. 18, 2025

Related U.S. Application Data
(60) Provisional application No. 63/688,951, filed on Aug. 30, 2024.

(51) Int. Cl. F17C 9/04; F01D 15/00; F25J 1/02; F25J 3/04

(52) U.S. Cl. CPC F17C 9/04; F01D 15/005; F25J 1/0242; F25J 3/04169; F25J 2205/60; F25J 2240/10; F25J 2240/90

(57) ABSTRACT

A liquid air energy conversion system is provided that is a variant of conventional gas turbine combined cycle (GTCC) that integrates three subsystems or unit operations, namely a main air compression and pre-purification subsystem, a deep sub-ambient gas compression subsystem, and a power expansion and waste heat recovery subsystem. The disclosed liquid air energy conversion system enhances and optimizes the energy extraction from liquid air by avoiding main air compression directly associated with the gas turbine and the air fed to the overall system and process is limited to the air flow required to vaporize the liquid air.

### CROSS REFERENCE TO RELATED APPLICATIONS

This application claims the benefit of and priority to U.S. provisional patent application Ser. No. 63/688,951 filed on Aug. 30, 2024 the disclosure of which is incorporated by reference.

### TECHNICAL FIELD

The present invention relates generally to liquid air energy conversion system and associated methods, and more particularly, to the integration of gas turbine power generation with liquid air energy conversion to produce electrical energy from liquid air energy storage systems.

### BACKGROUND

There is a continuing need to develop and demonstrate new energy storage and associated energy discharge systems and technologies that are both technically feasible and commercially viable. Such energy storage and discharge systems and technologies should have the capacity to discharge energy for a duration of greater than 10 hours at rated power and at a levelized cost of storage of about $0.05/kWh-cycle at some point in the near future. The targeted energy storage and discharge systems should be at a mega-watt scale. Moreover, new energy storage systems and technologies should be long duration storage systems able to supply power for weekly or monthly durations and have a capacity to continuously discharge energy on a daily or diurnal cycle for between 10 hours to 100 hours or more.

Liquid air energy storage (LAES) is a known technology that is well suited for longer duration, and greater power generation magnitude than can be achieved economically with lithium-ion batteries. The liquefaction of ambient air can be accomplished at high efficiency with known gas turbo-expansion based equipment and processes. However, the effective extraction of the energy contained or stored within the liquid air is far more difficult challenge. Roughly 50% of the energy contained within liquid air is contained in the cryogenic, sub-ambient state. Conventional approaches to extraction and recovery of this energy from liquid air involve periodic heat exchange with cold stores (i.e. solids and liquids of high thermal capacitance) as generally disclosed in United States Patent Application Publications US2017/0022897 and US2023/0408188.

The cost and complexity of conventional LAES systems, including those that employ the use of cold stores, is relatively high and thus a barrier to widespread adoption and use in the long duration energy storage market. Unlike most other energy storage technologies, LAES systems often require mostly discrete and separate equipment for the charging step and the generating step, which represents a fundamental problem. To realize widespread adoption of LAES based systems, there must be a significant cost reduction of the LAES equipment or, more preferably, a step change in the extraction and recovery of energy from the liquid air.

Such step changes in the extraction and recovery of energy from the liquid air or the power discharge phase of LAES systems involves maximizing the potential power generated from liquid air by using energy from associated systems. One such approach would be integration of conventional gas turbine power generation with liquid air energy extraction. To advance such an approach, there is a need to develop technically and economically viable processes which effectively integrate with the pressure levels and flows between LAES systems and conventional gas turbine power generation systems, and to find ways to utilize available waste heat from conventional gas turbine power generation systems.

### SUMMARY

The present liquid air energy conversion system and method may be broadly characterized comprising: (1) a main compression and pre-purification subsystem configured for compressing a feed cryogenic gas stream to yield a low pressure cryogenic gas stream and purifying the low pressure cryogenic gas stream to yield a pre-purified, low pressure cryogenic gas stream; (2) a deep sub-ambient gas compression subsystem configured to: (a) receive a liquid air stream and pump the liquid air stream to a supercritical pressure yielding one or more supercritical liquid air streams; (b) vaporize the one or more supercritical liquid air streams via indirect heat exchange against the purified, low pressure cryogenic gas stream to yield one or more very high pressure air streams and one or more cooled, purified, low pressure cryogenic gas streams; and (c) compress the one or more cooled, purified, low pressure cryogenic gas streams in one or more compressors, including at least one cold compressor to yield one or more moderate pressure, high pressure and/or very high pressure gas streams; and (3) a power expansion and waste heat recovery subsystem configured to: (a) receive a stream of combustion gas and expand the combustion gas to yield a flue gas exhaust stream and shaft work used to create a first source of electrical power; (b) warm all of or a portion of the one or more very high pressure air streams and/or all of or a portion of the one or more moderate pressure, high pressure or very high pressure gas streams to yield one or more warmed streams via indirect heat exchange with the flue gas exhaust stream; and (c) expand the one or more of the warmed streams in one or more turbine-expanders to produce one or more exhaust streams and shaft work used to create one or more auxiliary sources of electrical power. The cryogenic gas is preferably a gas that has a normal boiling point equal to or less than −150° C., and more preferably an air stream at a pressure in the range of about 3 bar(a) to 10 bar(a) while the combustion gas is produced from the combustion of a fuel source, such as natural gas, hydrogen, or a combination of both, with the exhaust streams or other stream originating from the deep sub-ambient gas compression subsystem.

In some preferred embodiments of the liquid air energy conversion system, the main compression and pre-purification subsystem of the further comprises: (i) one or more main compressors or compression stages configured for compressing a feed cryogenic gas stream to yield the low pressure cryogenic gas stream; and (ii) an adsorption-based pre-purification unit, such as a Temperature Swing Adsorption (TSA) unit, configured for purifying the low pressure cryogenic gas stream to yield the pre-purified, low pressure cryogenic gas stream. Also, the deep sub-ambient gas compression subsystem in such embodiments further comprises: (iii) one or more liquid air pumps configured for receiving the liquid air stream and pumping the liquid air stream to a supercritical pressure yielding one or more supercritical liquid air streams; (iv) a main heat exchanger configured to vaporize the one or more supercritical liquid air streams via indirect heat exchange against the purified, low pressure cryogenic gas stream to yield the one or more very high pressure air streams and the one or more cooled, purified, low pressure cryogenic gas streams; and (v) the one or more compressors, including the at least one cold compressor configured to compress the one or more cooled, purified, low pressure cryogenic gas streams to yield the one or more moderate pressure, high pressure and/or very high pressure gas streams. Finally, the power expansion and waste heat recovery subsystem of such embodiments still further comprise; (vi) a gas turbine configured to receive the stream of combustion gas and expand the combustion gas to yield a flue gas exhaust stream and shaft work used to create the first source of electrical power; (vii) a flue gas heat exchanger configured to warm the one or more very high pressure air streams via indirect heat exchange with the flue gas exhaust stream to yield a first warmed stream, and warm the one or more moderate pressure, high pressure or very high pressure gas streams via indirect heat exchange with the flue gas exhaust stream to yield at least a second warmed stream; and (viii) the one or more turbine-expanders configured to expand the first warmed stream and/or the second warmed stream to produce the one or more exhaust streams and shaft work used to create the one or more auxiliary sources of electrical power or to impart power to one or more compression stages in the main compression and pre-purification subsystem or to impart power to the one or more compressors in the deep sub-ambient gas compression subsystem.

In selected embodiments, the one or more compressors of the deep sub-ambient compression subsystem further comprise at least one cold compressor configured to compress the one or more cooled, purified, low pressure cryogenic gas streams to form a cold compressed gas stream and one or more auxiliary compressors configured to further compress all of or a portion of the cold compressed gas stream to yield one or more auxiliary discharge streams at high pressures or very high pressures. A first portion of the cold compressed gas stream, preferably in the range of 20% to 50% by volume, may be re-directed back to the main heat exchanger. The warmed portion of the cold compressed gas stream is optionally expanded in a warm turbine-expander that is also recycled back to the main heat exchanger to provide refrigeration to the cooling lower pressure air stream.

### BRIEF DESCRIPTION OF THE DRAWINGS

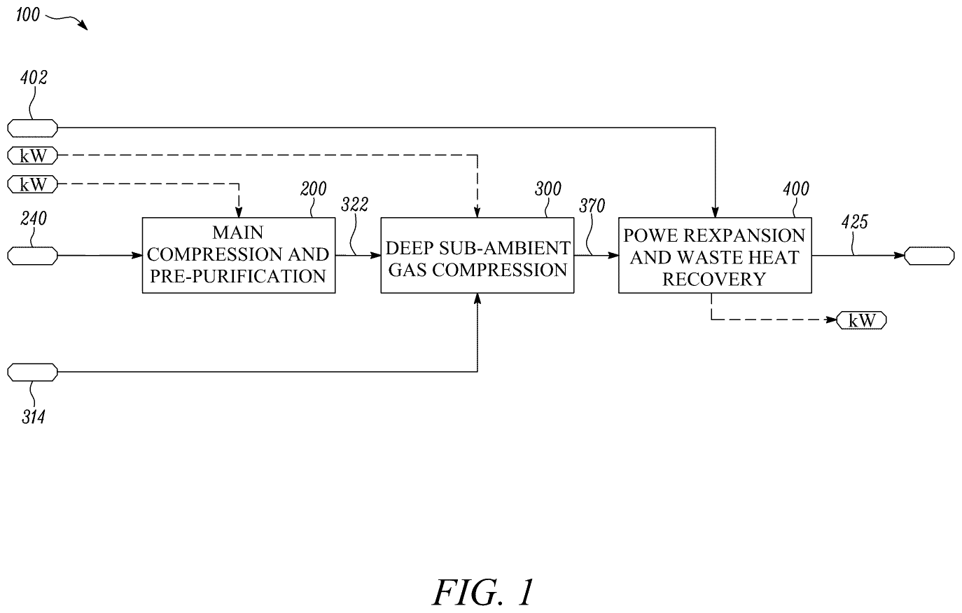

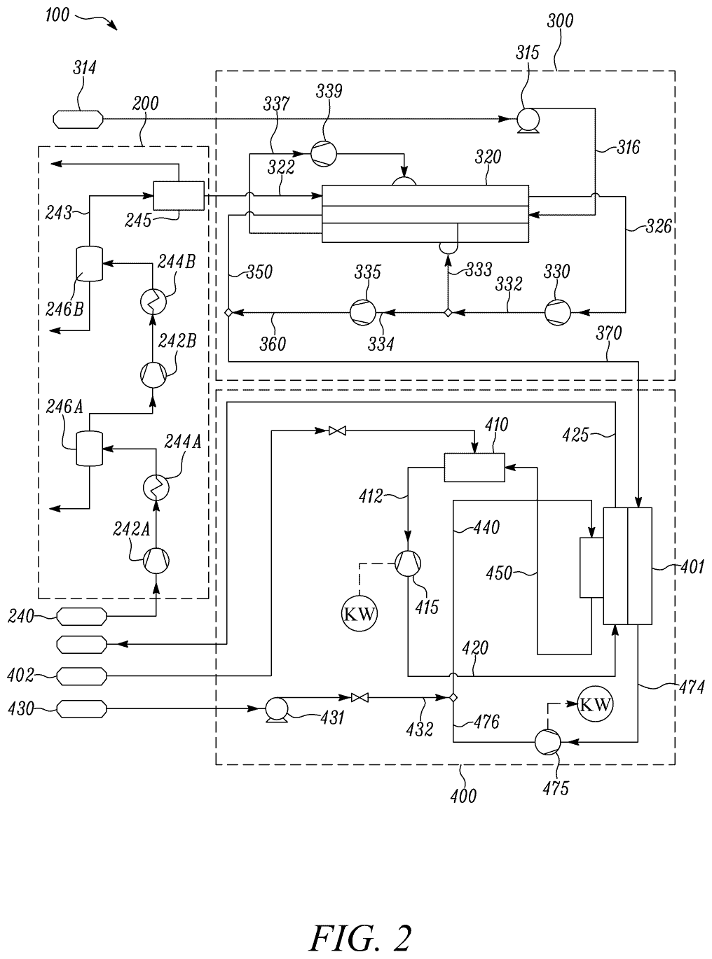

Aspects, features, and advantages of the present system and method will be more apparent from the following detailed description taken in conjunction with the drawings in which FIG. 1 is an illustration of an embodiment of the present system and method and FIG. 2 is a more detailed schematic illustration of an embodiment of the system and method depicted in FIG. 1.

### DETAILED DESCRIPTION

As used herein, the term or phrase ‘low pressure’ means a pressure near ambient, and more particularly at a pressure of 10 bar(a) or less whereas the term or phrase ‘moderate pressure’ refers to a pressure that might exist at the gas turbine inlet in a conventional gas turbine based power recovery section of the liquid air energy conversion system, and more particularly a pressure between 10 bar(a) to about 50 bar(a). Likewise, the term or phrase ‘high pressure’ refers to a pressure in the range of about 50 bar(a) and 75 bar(a) whereas the term or phrase. ‘very high pressure’ s used herein refers to a pressure where the fluid is substantially supercritical, and in the case of liquid air energy conversion, preferably to a pressure greater than 75 bar(a).

From a definition standpoint the term or phrase ‘air’ and ‘air stream’ as used herein should be construed to mean an oxygen and nitrogen containing stream that has an oxygen concentration not less than 10%. However, the term or phrase ‘liquid air’ should be understood to include cryogenic liquids having a nitrogen content greater than or equal to 70%, so as to include liquified air as well as liquid nitrogen. Also, the term or phrase ‘cryogenic gas’ being defined to mean a gas possessing a boiling point less than −150° C. or more broadly as a gas that would not condense as it is cooled by the warming supercritical air. Lastly, the term or phrase ‘cold compression’ generally means compression of a gas having an inlet temperature of −50° C. or lower.

This present system and method has been developed for purposes of improving the discharge of energy/power from a liquid air energy storage (LAES) facility. Processes for the high efficiency liquefaction of air (i.e. the charging phase) are well established. In contrast, effective processes for extracting the energy/power from liquefied air have not yet been fully optimized. The subject processes eliminate the conventional use of a “cold store” process while simultaneously extracting the maximum value from the sub-ambient thermal aspects of liquid air.

As shown in FIG. 1, the present system and method is broadly characterized as involving three integrated subsystems or unit operations, namely a main compression and pre-purification subsystem 200, a deep sub-ambient compression subsystem 300, and a power expansion and waste heat recovery subsystem 400. In essence, the illustrated system and process for liquid air energy conversion is a variant of a combustion gas turbine arrangement typically found in commercial gas turbine cycles. Given that the combustion turbine used in many modern gas turbine cycles is near the limits of both materials and aerodynamic performance, the present approach optimizes the energy extraction by targeting such conditions upstream of the combustion turbine of a gas turbine cycle.

More specifically, the main compression and pre-purification subsystem 200 receives a source of a cryogenic gas 240, such as ambient air. Within the main compression and pre-purification subsystem 200, the ambient temperature cryogenic gas is compressed to a relatively low pressure suitable for pre-purification, preferably in a range of 3 bar(a) to 10 bar(a) and is then pre-purified in an adsorption-based pre-purification unit to yield a stream of pre-purified, low pressure cryogenic gas 322. Power input (kw) is also required by the main compression and pre-purification subsystem 200.

The deep sub-ambient compression subsystem 300 receives a source of liquid air 314, pumps the liquid air preferably to a supercritical pressure and vaporizes the supercritical liquid air via indirect heat exchange with the stream of pre-purified, low pressure cryogenic gas 322 to yield a very high pressure air stream 350 and a cooled, pre-purified, low pressure cryogenic gas stream 326. As described in more detail below, the cooled, pre-purified, low pressure cryogenic gas stream 326 at a sub-ambient temperature is compressed in one or more compressors, including at least one cold compressor to yield one or more moderate pressure, high pressure and/or very high pressure gas streams. Additional power input (kw) is also required by the deep sub-ambient compression subsystem 300.

Ideally, the very high pressure air stream (350) is deeply supercritical, preferably at a pressure of about 70 bar(a) or higher and is then directed to the power expansion and waste heat recovery subsystem 400. In addition, the one or more moderate pressure, high pressure and/or very high pressure gas streams produced in the deep sub-ambient compression subsystem 300 are also directed to the power expansion and waste heat recovery subsystem 400.

The power expansion and waste heat recovery subsystem 400 is based on a gas turbine combined cycle power expansion arrangement that receives the very high pressure air stream as well as the one or more moderate pressure, high pressure and/or very high pressure gas streams from the deep sub-ambient compression subsystem 300 and an external fuel source 402. The power expansion and waste heat recovery subsystem 400 produces a combustion gas from the combustion of the external fuel source 402 with the one or more oxygen containing streams originating from the deep sub-ambient compression subsystem 300. The combustion gas is power expanded in the gas turbine to yield a flue gas exhaust stream at a pressure of about 1.1 bar(a) and a temperature nominally above its saturation point and shaft work used to create a first source of electrical power. In addition, the supercritical air stream and/or all of or a portion of the moderate pressure, high pressure or very high pressure gas streams from the deep sub-ambient compression subsystem 300 are warmed using the waste heat from the gas turbine cycle in a flue gas heat exchanger and then expanded in one or more auxiliary turbine-expanders to produce shaft work used to create auxiliary sources of electrical power. The cooled flue gas waste stream 425 exits the power expansion and waste heat recovery subsystem 400. Power output generated by the power expansion and waste heat recovery subsystem 400 greatly exceeds the combined power required by the main compression and pre-purification subsystem 200 and the deep sub-ambient compression subsystem 300.

The over-arching purpose of the illustrated system and method is to produce power from liquefied air. In this way, power stored during the charging phase of a LAES cycle can be productively released. To enhance the power producing objective, power is extracted in the form of compression energy. On a simple thermodynamic level, the power required to compress any gas is roughly proportionate to the temperature at which such compression occurs. In a conventional gas turbine cycle, the feed air compression to the moderate pressures upstream of the combustor typically occurs adiabatically starting from ambient temperatures, whereas in the present system and method, compression of air or other oxygen-containing gases for production of combustion gas to be expanded by the gas turbine occurs partially at sub-ambient temperatures in deep sub-ambient compression subsystem.

In other words, by reducing the power required for such air compression required by the gas turbine cycle, the net power output of the overall system is increased. Put another way, by using the cooling and deep refrigeration afforded by liquid air to lower the power consumed in air compression, the present system and method produces significantly more output power relative to the fuel consumed than conventional gas turbine cycles.

One characterizing aspect of the present system and method is found in the fact that there is no dedicated air compression arrangement directly coupled to the main combustion fired gas turbine. A conventional gas turbine cycle employs a combustion turbine which provides both export shaft work/power as well as the shaft work require to compress the main combustion air. In the present system and process, the gas flow that is ultimately directed to the final combustion turbine is the air derived from the liquid air vaporization and/or the gas streams from the one or more moderate pressure, high pressure and/or very high pressure gas streams from the deep sub-ambient compression subsystem 300.

Turning now to FIG. 2, there is shown a more detailed process flow diagram (PFD) of one embodiment of the present system and method. Each of the three integrated subsystems, and more particularly, the main compression and pre-purification subsystem 200, the deep sub-ambient compression subsystem 300, and the power expansion and waste heat recovery subsystem 400 in the illustrated embodiment are detailed in the paragraphs that follow.

### Main Compression and Pre-Purification

Multi-stage ambient air compression is a well-established process technology. In the illustrated embodiment, the main compression and pre-purification subsystem 200 receives a source of a cryogenic gas 240, such as ambient air and compresses the gas in a series of compression stages 242A, 242B. Although such compression may be conducted adiabatically without intercooling, the heat of compression from the multiple compression stages 242A, 242B is preferably dissipated by intercoolers 244A, 244B to an ambient utility and condensed water is removed using one or more phase separators 246A, 246B. If the air compression is conducted adiabatically, the heat of compression may be extracted by way of a gas/gas heat exchanger which could serve to heat the resulting very high pressure gas 370 or to heat the purge gas used in the pre-purification unit 245. Alternatively, a waste heat recovery process could be configured using an additional working fluid. Methods and/or cycles associated with the recovery of low-grade waste heat are known and given the scale of present operation could be applied within the present system and method.

The low pressure cryogenic gas 243, preferably at a low pressure in the range of 3 bar(a) to 10 bar(a) is pre-purified in a pre-purification unit 245 prior to entry into the cryogenic deep sub-ambient gas compression subsystem 300. Operation with even lower pressure air less than about 3 bar(a) is possible, however such systems ate typically not economical. Such pre-purification unit 245 is preferably a temperature swing adsorption (TSA) based unit, although other purification methods and combinations of methods are possible. The stream of pre-purified, low pressure cryogenic gas 322 exiting the pre-purification unit 245 and entering the deep sub-ambient gas compression coldbox must be substantially free of water, carbon dioxide, and other deep condensable contaminants. Such contaminants would interfere with continuous and steady operation of the sub-ambient gas compression subsystem 300.

Although not shown, the stream of low pressure, pre-purified cryogenic gas 322 is preferably an air stream at a pressure in the range of 3 bar(a) to 10 bar(a) and may actually be provided from a nearby air separation plant.

### Deep Sub-Ambient Gas Compression

Liquid air from a low pressure storage tank 314 or other source of liquid air, is first pumped via one or more pumps 315 preferably to a supercritical pressure, and more preferably to a pressure of about 70 bar(a) or higher and then directed into multi-stream main heat exchanger 320 where it is vaporized and warmed to near ambient temperatures. Although shown as a single pump 315, the system may include multiple pumps arranged in a serial orientation or a parallel orientation. Vaporizing the pumped supercritical liquid air stream 316 in the main heat exchanger 320 is accomplished via indirect heat exchange against at least the pre-purified, low pressure cryogenic gas 322. A flow ratio between the pre-purified, low pressure cryogenic gas 322 and the supercritical liquid air stream 316 is about 2.0 which is required to vaporize substantially all of supercritical liquid air and yield a supercritical air stream 350. The pre-purified, low pressure cryogenic gas 322 is substantially cooled to near saturation and the cooled, purified, low pressure cryogenic gas stream 326 is then directed to an initial cold compressor 330. The cooled, purified, low pressure cryogenic gas stream 326 is compressed to a moderate pressure of greater than about 5.0 times the pre-purified, low pressure cryogenic gas stream 322 to yield a moderate pressure cryogenic gas stream 332. The compression ratio of 5× is desirable from the standpoint of economical compression and the refrigeration needs at a warm end of main heat exchanger 320.

The flow of the pre-purified, low pressure cryogenic gas stream 322 is preferably designed or determined to achieve a close temperature approach of the cooling curves (i.e. about 2.0° C.) near the cold end of main heat exchanger 320. Such a flow rate of the pre-purified, low pressure cryogenic gas stream 322 results in potential thermal cross-over near the warm end of the main heat exchanger core. To resolve this, a small amount of supplemental warm end refrigeration is provided by way diverting a first portion 333 of the moderate pressure cryogenic gas stream back to an intermediate location of the main heat exchanger 320 and warm the diverted first portion 333 in the main heat exchanger 320 to near ambient temperature. The warmed first portion of the moderate pressure cryogenic gas stream 337 is then expanded in warm turbine 339 to a pressure roughly equal to the low pressure pre-purified, cryogenic gas stream with the resulting exhaust stream returned back to the main heat exchanger 320, preferably to another intermediate location of the main heat exchanger 320 to provide supplemental refrigeration. The diverted first portion 333 of the cold compressed gas stream is preferably less than 50% by volume of the entire cold compressed gas stream 322, and more preferably less than 25% by volume of the entire cold compressed gas stream 322. In alternate embodiments, the warm turbine may be arranged to expand a stream of excess air from the Main Compression and Pre-Purification subsystem that is then warmed in the main heat exchanger to provide any required supplemental refrigeration

The remaining portion or second portion 334 of the moderate pressure cryogenic gas stream is then further compressed in the auxiliary compressor 335 to a high pressure, or more preferably to very high pressure in excess of 70 bar(a). This further compressed gas stream 360 generally exit auxiliary compressor 335 near ambient temperature or a super-ambient temperature and may be combined with the warmed/vaporized pumped supercritical liquid air stream 350 to create a combined very high pressure air stream 370 for purposes of sendout or distribution to the power generation and waste heat recovery subsystem 400.

It should be noted that if the temperature of the further compressed gas stream 360 is below the warm end temperature of main heat exchanger 320, the further compressed gas stream 360 may then be further warmed in main heat exchanger 320 and then combined with the vaporized supercritical air stream 350.

In any arrangement where the warm turbine 339 is used, it should be noted that the shaft work resulting from the warm turbine 339 may be imparted to the cold compressor 330 or auxiliary compressor 335 to reduce the net power required by the deep sub-ambient gas compression or the shaft work may be operatively coupled to a generator to generate additional electric power. Although illustrated as a single main heat exchanger, additional or separate refrigeration circuits could be employed to provide the necessary refrigeration to rectify or address the potential deficiency of warm end refrigeration.

In alternate embodiments of the present system and method, the deep sub-ambient compression subsystem 300 may be configured to direct portions of the moderate pressure gas stream 337, a high pressure gas stream 360, and/or the very high pressure gas stream 350 separately to the power generation and waste heat recovery subsystem 400.

### Power Expansion and Waste Heat Recovery

Turning back to FIG. 2, the combined very high pressure gas stream 370 derived from the deep sub-ambient gas compression subsystem 300 is directed to a combined cycle power generation process depicted as the power generation and waste heat recovery subsystem 400. The power generation and waste heat recovery subsystem 400 may be broadly characterized as a gas turbine combined cycle (GTCC) type process. However, there are several key distinctions or differences in the illustrated embodiment from a conventional GTCC employing steam for purposes of waste heat recovery. The first key difference or distinction is that the gas turbine 415 and the flue gas heat exchanger 401 are configured to accommodate the vaporized liquid air and the returning compressed air flows. To this end, there is no main air compression directly associated with the gas turbine. The air fed to the overall system and process is the air flow required to only vaporize the liquid air. A second key difference or distinction is that the optimized performance or flue gas heat exchanger 401 (i.e. closeness of the temperatures of the warming and cooling streams within the flue gas heat exchanger) results in a decrease in the combustion feed air temperature (stream 450) and a slight increase in fuel consumption (402).

The illustrated embodiment of the power generation and waste heat recovery subsystem 400 incorporates two power expansion stages to produce electricity. The first power expansion stage involves expansion of the combined very high pressure gas stream 370 derived from the deep sub-ambient gas compression subsystem 300 in a turbine-expander 475 while the second power expansion stage involves expansion of a combustion gas 412 in a gas turbine 415. The combustion gas 412 is produced from the combustion of a fuel source 402 with a warmed exhaust stream 450 from the turbine-expander 475 in the first power expansion stage.

In alternate embodiments, the first stage of power expansion may be disaggregated into multiple stages of expansion using one or more turbine-expanders. As indicated above, the power generation and waste heat recovery subsystem 400 may be configured to also receive a moderate pressure gas stream and/or a high pressure gas stream from the deep sub-ambient gas compression subsystem 300. Where multiple streams of differing pressure are received, the first stage of power expansion may employ multiple turbine-expanders, each providing shaft work that is used to create one or more auxiliary sources of electrical power. Alternatively, shaft work from the one or more turbine-expanders in the first stage of power expansion may be operatively coupled to the main air compressor stages 242A, 242B of the main compression and pre-purification subsystem 200 or the cold compressor 330 and/or the auxiliary compressor 335 of the deep sub-ambient gas compression subsystem 300.

In the embodiment shown in FIG. 2, the combined very high pressure gas stream 370 is substantially warmed within the flue gas exchanger 401. The warmed very high pressure gas stream 474 is subsequently expanded in turbine-expander 415 to a moderate pressure, preferably in the range of 10 bar(a) and 50 bar(a). The moderate pressure exhaust stream 476 is then optionally hydrated with an external source of water 420 pumped via water pump 430 to yield a hydrated moderate pressure exhaust stream 440. The hydrated moderate pressure exhaust stream 440 is then further warmed in the flue gas heat exchanger 401. The warmed, hydrated moderate pressure exhaust stream 450 is then combined with a fuel source 402, such as natural gas or hydrogen or a combination of both natural gas and hydrogen, and combusted in a combustion device 410 to yield a very high temperature combustion gas 412 at a temperature near about 1500° C. The very high temperature combustion gas 412 is then directed to the gas turbine 415 which expands the combustion gas 412 to yield a flue gas exhaust stream 420 at a pressure nominally above ambient pressure and a temperature in the range of 550° C. to 700° C. as well as shaft work used to create electrical power. The flue gas exhaust stream 420 is then cooled against the combined very high pressure gas stream 370 and the moderate pressure exhaust stream 450 to produce a cooled vent gas 425 nominally above the saturation point.

Alternate embodiments of the present system and method also contemplate hydration of the very high pressure air stream at the exit of the deep sub-ambient gas compression subsystem. Water can also be boiled in the flue gas heat exchanger and then combined with either the combustion gas or any of the moderate pressure, high pressure, or very high pressure streams upstream of the turbine expanders.

### Process Optimization

The present system and method of liquid air energy conversion has been subjected to computer-based thermodynamic simulations for purposes of optimizing the conditions necessary to achieve a minimum in heat rate and to perform parametric analysis.

For each of these simulations, all the turbo-expansions (See turbine expanders 339, 415, and 475) have assumed an adiabatic efficiency of 90%. The cryogenic gas is air and the feed air compression in compression stages 242A and 242B as well as compression of the cryogenic gas in cold compressor 330 and auxiliary compressor 335 have assumed an adiabatic compression efficiency of 85%. The discharge pressure of the gas turbine 415 has been specified to be 1.1 bar(a). The main heat exchanger 320 has assumed that all endpoint temperatures and internal temperature approaches are targeted for 2.0° C. The flue gas heat exchanger 401 has assumed no internal temperature approach less than 50.0° C. The fuel source 402 is assumed to be pure methane (CH4). The approach temperatures on the aftercoolers (244A, 244B) were assumed to be 30.0° C. while the feed air temperature has been assumed to be 25.0° C.

As indicated above, the process simulations have been conducted assuming that a fixed flowrate of liquid air must be vaporized. All other flows, temperatures and pressures are configured to accommodate this fixed liquid air flow. Simulation of the overall system requires the definition of four primary pressures, namely:
1) Discharge pressure of Main Compression and Pre-Purification Subsystem (i.e. pre-purified, low pressure gas stream 322) to be at a pressure of less than about 10 bar(a);
2) Discharge pressure of the cold compressor 330 (i.e. moderate pressure gas stream 332) to be at a moderate pressure in a range of 10 bar(a) and 30 bar(a);
3) Vaporization pressure of the liquid air (i.e. very high pressure air stream 350 or combined very high pressure air stream 370) to be at a pressure of 70 bar(a) or higher; and
4) Inlet pressure of the gas turbine (415) (and discharge pressure of exhaust stream 476) to be at a moderate pressure in a range of 15 bar(a) and 40 bar(a).

Once these four primary pressures have been targeted, the interior temperature approaches within the main exchanger 320 must be achieved by adjusting the cold end exit temperature of the pre-purified, low pressure gas stream 326, as well as the pre-purified, low pressure feed air flow. The fraction of the diverted first portion 333 of the cold compressed gas stream is then set by obtaining a suitable warm end temperature approach (or warm end delta temperature) of 2.0° C. for the main heat exchanger 320.

It should be noted that the optimized flow of the combined very high pressure air to the Power Expansion and Waste Heat Recovery subsystem 400 is roughly three times (3×) the original specified liquid air flow. Put another way, the volume of low pressure air compressed and pre-purified in the Main Compression and Pre-Purification subsystem 200 is roughly twice the flow of liquid air to the Deep Sub-Ambient Gas Compression subsystem 300.

The design of the Power Expansion and Waste Heat Recovery subsystem 400 is largely defined by the selected pressure of the combined very high pressure air stream 370 received. The only adjustment and/or optimization necessary is to specify the performance of the flue gas heat exchanger 401, and more specifically, the exit temperature of the warmed exhaust stream 450 directed to the combustion device 410 which in turn impacts the temperature of the combustion gas 412 sent to the gas turbine 415. The design of the turbine-expander 475 is defined by the pressure of the combined very high pressure air stream and the desired inlet pressure of the gas turbine. The inlet temperature to the turbine-expander 475 is preferably obtained by applying the 50° C. temperature approach in the flue gas exhaust stream 420.

Each of the four process optimization scenarios are detailed in the sections that follow.

### Optimization Scenario #1

The impact of the selected pressure for the pre-purified, low pressure feed air on overall system performance was evaluated. The following table (i.e. Table 1) shows the results of this optimization scenario. For this simulation, the compression ratio across the cold compressor is maintained at 5.0 which maintains a roughly constant temperature rise across the cold compressor. In addition, combined very high pressure air stream and the gas turbine inlet pressures were held constant in the simulation. As seen in Table 1, the heat rate and efficiency indicate a non-negligible improvement as the pressure for the pre-purified, low pressure feed air is reduced. In other words, there is a clear preference of system operation toward lower feed air pressures and the thermodynamic optimum probably exists when the pre-purified, low pressure feed air is between 2.0 bar(a) and 3.0 bar(a). However, the actual economic optimum configuration may actually reside at a slightly higher pressure for the pre-purified feed air because of the likely increase in capital expense associated with very low pressure pre-purification systems. Pre-purification of low pressure feed air between 2.0 bar(a) and 3.0 bar(a) is most likely cost prohibitive. Therefore, operating the main compression and pre-purification subsystem at maximum pressures in the range of about 5 bar(a) to 6 bar(a) is a more favorable pressure for temperature swing adsorption (TSA) base pre-purification units. In addition, in various operating scenarios where a portion of the pre-purified, low pressure air stream is diverted to an air liquefaction process as part of the LAES charging phase, pressures in the range of 5 bar(a) to 6 bar(a) is more favorable for air liquefaction.

TABLE 1
Impact of Pre-Purified, Low Pressure Feed Air Pressure upon System Performance

| | | | | | | |
|---|---|---|---|---|---|---|
| Pressure | Pre-Purified, Low Pressure | 2.00 | 3.00 | 4.00 | 5.00 | 5.80 |
| bar(a) | Feed Air Pressure | | | | | |
| | Cold Compressor Outlet | 10.00 | 15.00 | 20.00 | 25.00 | 29.00 |
| | Pressure | | | | | |
| | Combined Very High Pressure | 100.00 | 100.00 | 100.00 | 100.00 | 100.00 |
| | Air Pressure (sendout) | | | | | |
| | Gas Turbine Inlet Pressure | 40.00 | 40.00 | 40.00 | 40.00 | 40.00 |
| Flow Ratio | Ratio of GAIR/LAIR in Deep | 1.959 | 1.954 | 1.948 | 1.937 | 1.929 |
| | Sub-Ambient Gas Compression | | | | | |
| | Ratio of CH4/LAIR | 0.086 | 0.086 | 0.086 | 0.086 | 0.085 |
| Temperature | Cooled, Low Pressure Air | −174.73 | −174.23 | −173.47 | −173.12 | −172.83 |
| ° C. | Stream Temperature | | | | | |
| | Warmed, Moderate Pressure | 406.60 | 406.60 | 406.60 | 406.50 | 406.60 |
| | Exhaust Stream Temperature | | | | | |
| Unit Power | Liquid Air Pump | 0.005 | 0.005 | 0.005 | 0.005 | 0.005 |
| kwhr/kg-LAIR | Main Air Compression | 0.048 | 0.072 | 0.090 | 0.105 | 0.114 |
| | Deep Sub-Ambient Gas | 0.151 | 0.125 | 0.108 | 0.095 | 0.086 |
| | Compression | | | | | |
| | Air Liquefier (fixed) | 0.361 | 0.361 | 0.361 | 0.361 | 0.361 |
| | Power Expanders | 1.137 | 1.135 | 1.133 | 1.128 | 1.125 |
| | Net Power | 0.571 | 0.572 | 0.569 | 0.563 | 0.558 |
| kj/kwhr | Heat Rate | 7541 | 7519 | 7552 | 7602 | 7640 |
| (LHV) | | | | | | |
| — | Efficiency | 47.74% | 47.88% | 47.67% | 47.36% | 47.12% |

### Optimization Scenario #2

The impact of the selected pressure for cold compressor outlet pressure on overall system performance pressure was also evaluated. The variation of the outlet pressure of the cold compressor changes the temperature at which the warm turbine-expander delivers refrigeration to the process. As the expansion ratio of the warm turbine-expander increases, the temperature drop across the warm turbine-expander increases. As a result, the relative fraction of diverted moderate pressure air stream recycled to the warm-turbine expander may also be varied. A simple inspection of the resulting heat rate and efficiency in this optimization scenario indicates no meaningful impact of varying the cold compressor outlet pressure on overall system performance.

TABLE 2
Impact of Cold Compressor Outlet Pressure on System Performance

| | | | | | | |
|---|---|---|---|---|---|---|
| Pressure | Pre-Purified, Low Pressure | 3.00 | 3.00 | 3.00 | 3.00 | 3.00 |
| bar(a) | Feed Air Pressure | | | | | |
| | Cold Compressor Outlet | 10.00 | 11.00 | 12.00 | 13.00 | 15.00 |
| | Pressure | | | | | |
| | Combined Very High | 90.00 | 90.00 | 90.00 | 90.00 | 90.00 |
| | Pressure Air Pressure | | | | | |
| | (sendout) | | | | | |
| | Gas Turbine Inlet Pressure | 40.00 | 40.00 | 40.00 | 40.00 | 40.00 |
| Flow Ratio | Ratio of GAIR/LAIR in | 1.999 | 1.997 | 1.995 | 1.989 | 1.979 |
| | Deep Sub-Ambient Gas | | | | | |
| | Compression | | | | | |
| | Ratio of CH4/LAIR | 0.086 | 0.086 | 0.086 | 0.086 | 0.086 |
| Temperature | Cooled, Low Pressure Air | −173.13 | −173.37 | −173.55 | −173.97 | −174.52 |
| ° C. | Stream Temperature | | | | | |
| | Warmed, Moderate Pressure | 421.30 | 421.30 | 421.30 | 421.30 | 421.30 |
| | Exhaust Stream Temperature | | | | | |
| Unit Power | Liquid Air Pump | 0.005 | 0.005 | 0.005 | 0.005 | 0.005 |
| kwhr/kg-LAIR | Main Air Compression | 0.074 | 0.074 | 0.074 | 0.074 | 0.073 |
| | Deep Sub-Ambient Gas | 0.121 | 0.121 | 0.122 | 0.121 | 0.121 |
| | Compression | | | | | |
| | Air Liquefier (fixed) | 0.361 | 0.361 | 0.361 | 0.361 | 0.361 |
| | Power Expanders | 1.135 | 1.135 | 1.135 | 1.133 | 1.130 |
| | Net Power | 0.575 | 0.574 | 0.574 | 0.573 | 0.570 |
| kj/kwhr | Heat Rate | 7505 | 7504 | 7504 | 7506 | 7511 |
| (LHV) | | | | | | |
| — | Efficiency | 47.97% | 47.98% | 47.98% | 47.96% | 47.93% |

### Optimization Scenario #3

Starting from a case with a pre-purified, low pressure feed air pressure of 3.0 bar(a), the impact of the actual pressure of the combined very high pressure air stream on overall system performance pressure was examined. In this optimization scenario, the compression ratio across the cold compressor was held constant such that the compression ration across the auxiliary compressor increases with the subject cases as needed to achieve the target pressure of the. combined very high pressure air stream. The simulation results for this optimization scenario are shown in Table 3.

Analysis of the impact of the combined very high pressure air stream pressure is provided in Table 3. A limited variation in heat rate and overall system efficiency is apparent. A shallow optimum is observable at a pressure around 90 bar(a). It is quite likely that the expense and performance of the cold compressor will dictate the operating conditions of the present system. Similarly, the actual pressure of the combined very high pressure air stream can be selected to accommodate the cost/range of the cold compressor. In this optimization scenario, the peak pressure used in the simulation is appreciably lower than the 160 bar(a) maximum operating pressure of current BAHX technology. The limited variation of efficiency with respect to the very high pressure air stream pressure is attributable to the deep supercritical nature of the vaporized liquid air.

TABLE 3
Impact of Very High Pressure Air Stream Pressure on System Performance

| | | | | | |
|---|---|---|---|---|---|
| Pressure bar(a) | Pre-Purified, Low Pressure | 3.00 | 3.00 | 3.00 | 3.00 |
| | Feed Air Pressure | | | | |
| | Cold Compressor Outlet | 15.00 | 15.00 | 15.00 | 15.00 |
| | Pressure | | | | |
| | Combined Very High Pressure | 80.00 | 90.00 | 100.00 | 110.00 |
| | Air Pressure (sendout) | | | | |
| | Gas Turbine Inlet Pressure | 40.00 | 40.00 | 40.00 | 40.00 |
| Flow Ratio | Ratio of GAIR/LAIR in Deep | 2.005 | 1.979 | 1.954 | 1.930 |
| | Sub-Ambient Gas | | | | |
| | Compression | | | | |
| | Ratio of CH4/LAIR | 0.085 | 0.086 | 0.086 | 0.086 |
| Temperature | Cooled, Low Pressure Air | −174.87 | −174.52 | −174.23 | −173.97 |
| ° C. | Stream Temperature | | | | |
| | Warmed, Moderate Pressure | 438.30 | 421.30 | 406.60 | 393.40 |
| | Exhaust Stream Temperature | | | | |
| Unit Power | Liquid Air Pump | 0.004 | 0.005 | 0.005 | 0.006 |
| kwhr/kg-LAIR | Main Air Compression | 0.074 | 0.073 | 0.072 | 0.071 |
| | Deep Sub-Ambient Gas | 0.116 | 0.121 | 0.125 | 0.128 |
| | Compression | | | | |
| | Air Liquefier (fixed) | 0.361 | 0.361 | 0.361 | 0.361 |
| | Power Expanders | 1.123 | 1.130 | 1.135 | 1.139 |
| | Net Power | 0.567 | 0.570 | 0.572 | 0.573 |
| kj/kwhr (LHV) | Heat Rate | 7513 | 7511 | 7519 | 7534 |
| — | Efficiency | 47.92% | 47.93% | 47.88% | 47.79% |

### Optimization Scenario #4

Starting from a case with a 90 bar(a) pressure for the combined very high pressure air stream and a 3.0 bar(a) pressure of the pre-purified, low pressure feed air, the impact of the combustion gas turbine inlet pressure on the overall system performance pressure was examined. The results of this evaluation are shown in the Table 4. The inlet temperature of the gas turbine has been held constant at 1500° C. Higher inlet temperatures between 1500° C. and 1700° C. are known to be possible, but typically at increased capital costs for the gas turbine.

In this optimization scenario, a clear increase in overall system efficiency is apparent as gas turbine inlet pressure is increased. This is somewhat to be expected since a similar behavior is evident in conventional gas turbine cycles. It is generally advantageous to minimize the quantity of waste heat by way of increasing the expansion ratio of the gas turbine. The temperature drop across the gas turbine increases with increasing expansion ratio. As the flue gas exhaust temperature (stream 420) falls the available waste heat also falls (i.e. energy difference between stream 420 and 425). However, from the standpoint of equipment specifications, the full economic optimum scenario may not actually reside at the highest possible combustion turbine inlet pressure. It is suspected that the expense of the final power expansion will have a strong correlation to the expansion ratio of the combustion gas turbine.

It should be noted that as the combustion gas turbine expansion ratio increases the reheat temperature of the warmed, moderate pressure air stream exiting the flue gas heat exchanger stays relatively stable. The outlet pressure of the turbine-expander and of the exhaust stream increases with decreasing ratio. At higher gas turbine expansion ratios, the exhaust temperature of the exhaust stream from the turbine-expander approaches the reheat temperature of the warmed, moderate pressure air stream exiting the flue gas heat exchanger. Consequently, it may be possible to forgo the reheat step altogether possibly reducing the capital costs of the flue gas heat exchanger and the exhaust stream from the turbine-expander would then be sent directly to the combustion device.

TABLE 4
Impact of Gas Turbine Inlet Pressure upon System Performance

| | | | | | | |
|---|---|---|---|---|---|---|
| Pressure | Pre-Purified, Low Pressure | 3.00 | 3.00 | 3.00 | 3.00 | 3.00 |
| bar(a) | Feed Air Pressure | | | | | |
| | Cold Compressor Outlet | 15.00 | 15.00 | 15.00 | 15.00 | 15.00 |
| | Pressure | | | | | |
| | Combined Very High | 90.00 | 90.00 | 90.00 | 90.00 | 90.00 |
| | Pressure Air Pressure | | | | | |
| | (sendout) | | | | | |
| | Gas Turbine Inlet Pressure | 15.00 | 20.00 | 30.00 | 40.00 | 50.00 |
| Flow Ratio | Ratio of GAIR/LAIR in | 1.979 | 1.979 | 1.979 | 1.979 | 1.979 |
| | Deep Sub-Ambient Gas | | | | | |
| | Compression | | | | | |
| | Ratio of CH4/LAIR | 0.085 | 0.085 | 0.085 | 0.086 | 0.086 |
| Temperature | Warmed, Moderate Pressure | 432.00 | 427.20 | 422.80 | 421.40 | 421.40 |
| ° C. | Air Stream Temperature | | | | | |
| | Warmed, Exhaust Stream | 398.67 | 400.37 | 404.33 | 408.28 | 412.13 |
| | Temperature | | | | | |
| Unit Power | Liquid Air Pump | 0.005 | 0.005 | 0.005 | 0.005 | 0.005 |
| kwhr/kg- | Main Air Compression | 0.073 | 0.073 | 0.073 | 0.073 | 0.073 |
| LAIR | Deep Sub-Ambient Gas | 0.121 | 0.121 | 0.121 | 0.121 | 0.121 |
| | Compression | | | | | |
| | Air Liquefier (fixed) | 0.361 | 0.361 | 0.361 | 0.361 | 0.361 |
| | Power Expanders | 1.118 | 1.123 | 1.128 | 1.130 | 1.131 |
| | Net Power | 0.559 | 0.564 | 0.569 | 0.570 | 0.571 |
| kj/kwhr | Heat Rate | 7585 | 7552 | 7522 | 7511 | 7508 |
| (LHV) | | | | | | |
| — | Efficiency | 47.46% | 47.67% | 47.86% | 47.93% | 47.95% |

While the present system and method has been described with reference to certain embodiments, various changes may be made without departing from the spirit and the scope of the disclosure, which is defined, not by the detailed description and embodiments, but by the appended claims and their equivalents.

What is claimed is:

1. A liquid air energy conversion system comprising:
a main compression and pre-purification subsystem configured for compressing a feed cryogenic gas stream to yield a low pressure cryogenic gas stream and purifying the low pressure cryogenic gas stream to yield a pre-purified, low pressure cryogenic gas stream;
a deep sub-ambient gas compression subsystem configured to: (a) receive a liquid air stream and pump the liquid air stream to a supercritical pressure yielding one or more supercritical liquid air streams; (b) vaporize the one or more supercritical liquid air streams via indirect heat exchange against the purified, low pressure cryogenic gas stream to yield one or more very high pressure air streams and one or more cooled, purified, low pressure cryogenic gas streams; and (c) compress the one or more cooled, purified, low pressure cryogenic gas streams in one or more compressors, including at least one cold compressor to yield one or more moderate pressure, high pressure and/or very high pressure gas streams;
a power expansion and waste heat recovery subsystem configured to: (a) receive a stream of combustion gas and expand the combustion gas to yield a flue gas exhaust stream and shaft work used to create a first source of electrical power; (b) warm all of or a portion of the one or more very high pressure air streams and/or all of or a portion of the one or more moderate pressure, high pressure or very high pressure gas streams to yield one or more warmed streams via indirect heat exchange with the flue gas exhaust stream; and (c) expand the one or more of the warmed streams in one or more turbine-expanders to produce one or more exhaust streams and shaft work used to create one or more auxiliary sources of electrical power;
wherein the combustion gas is produced from the combustion of a fuel source with one or more streams originating from the deep sub-ambient gas compression subsystem.

2. The liquid air energy conversion system of claim 1, wherein the main compression and pre-purification subsystem further comprises:
(i) one or more main compression stages configured for compressing a feed cryogenic gas stream to yield the low pressure cryogenic gas stream; and
(ii) an adsorption-based pre-purification unit configured for purifying the low pressure cryogenic gas stream to yield the pre-purified, low pressure cryogenic gas stream.

3. The liquid air energy conversion system of claim 2, wherein the deep sub-ambient gas compression subsystem further comprises:
(iii) one or more liquid air pumps configured for receiving the liquid air stream and pumping the liquid air stream to a supercritical pressure yielding one or more supercritical liquid air streams;
(iv) a main heat exchanger configured to vaporize the one or more supercritical liquid air streams via indirect heat exchange against the purified, low pressure cryogenic gas stream to yield the one or more very high pressure air streams and the one or more cooled, purified, low pressure cryogenic gas streams; and
(v) the one or more compressors, including the at least one cold compressor configured to compress the one or more cooled, purified, low pressure cryogenic gas streams to yield the one or more moderate pressure, high pressure and/or very high pressure gas streams.

4. The liquid air energy conversion system of claim 3, wherein the power expansion and waste heat recovery subsystem further comprises;
(vi) a gas turbine configured to receive the stream of combustion gas and expand the combustion gas to yield a flue gas exhaust stream and shaft work used to create the first source of electrical power;
(vii) a flue gas heat exchanger configured to warm the one or more very high pressure air streams via indirect heat exchange with the flue gas exhaust stream to yield a first warmed stream, and warm the one or more moderate pressure, high pressure or very high pressure gas streams via indirect heat exchange with the flue gas exhaust stream to yield at least a second warmed stream;
(viii) the one or more turbine-expanders configured to expand the first warmed stream and/or the second warmed stream to produce the one or more exhaust streams and shaft work used to create the one or more auxiliary sources of electrical power or to impart power to one or more compression stages in the main compression and pre-purification subsystem or to impart power to the one or more compressors in the deep sub-ambient gas compression subsystem.

5. The liquid air energy conversion system of claim 4, wherein the cryogenic gas is a gas that has a normal boiling point equal to or less than −150° C.

6. The liquid air energy conversion system of claim 4, wherein the wherein the cryogenic gas is an air stream at a pressure in the range of 3 bar(a) to 10 bar(a).

7. The liquid air energy conversion system of claim 6, wherein a portion of the air stream is diverted to a liquefaction subsystem configured to produce all or a portion of the liquid air stream and a second portion of the purified, low pressure cryogenic gas stream is directed to the main heat exchanger.

8. The liquid air energy conversion system of claim 7, wherein the pre-purification unit further comprises a temperature swing adsorption (TSA) based pre-purification unit.

9. The liquid air energy conversion system of claim 4, wherein the one or more compressors of the deep sub-ambient compression subsystem further comprise:
the at least one cold compressor configured to compress the one or more cooled, purified, low pressure cryogenic gas streams to form a cold compressed gas stream; and
one or more auxiliary compressors configured to further compress all of or a portion of the cold compressed gas stream to yield one or more auxiliary discharge streams which form the one or more high pressure gas streams and/or very high pressure gas streams.

10. The liquid air energy conversion system of claim 9, wherein a first portion of the cold compressed gas stream is directed to the main heat exchanger.

11. The liquid air energy conversion system of claim 10, wherein the first portion of the cold compressed gas stream is in the range of 20% to 50% by volume of the cold compressed gas stream.

12. The liquid air energy conversion system of claim 10, wherein the main heat exchanger is further configured to warm the first portion of the cold compressed gas stream via indirect heat exchange against the purified, low pressure cryogenic gas stream to yield the warmed, compressed cryogenic gas and the deep sub-ambient compression subsystem further comprises a warm turbine-expander configured to expand the warmed, compressed cryogenic gas to yield a cryogenic gas exhaust stream, and wherein the cryogenic gas exhaust stream is recycled to the main heat exchanger to provide refrigeration to the cooling lower pressure cryogenic stream.

13. The liquid air energy conversion system of claim 12, wherein the warm turbine-expander is further configured to impart power to one or more compression stages in the main compression and pre-purification subsystem or to impart power to the cold compressor or the one or more auxiliary compressors.

14. The liquid air energy conversion system of claim 9, wherein the one or more supercritical gas streams are combined with the one or more auxiliary discharge streams to form a combined very high pressure gas stream.

15. The liquid air energy conversion system of claim 13, wherein the flue gas heat exchanger is configured to cool the flue gas exhaust stream via indirect heat exchange with the combined very high pressure gas stream to yield a cooled waste stream and the first warmed stream.

16. The liquid air energy conversion system of claim 14, wherein the one or more turbine-expanders are configured to expand the first warmed stream to produce one or more exhaust streams and shaft work used to create one auxiliary source of electrical power.

17. The liquid air energy conversion system of claim 4, wherein the one or more exhaust streams are oxygen-containing gas streams at a pressure in the range of 10 bar(a) to 50 bar(a).

18. The liquid air energy conversion system of claim 4, wherein at least one of the one or more exhaust streams, the one or more moderate pressure, high pressure and/or very high pressure gas streams are hydrated with a source of water.

19. The liquid air energy conversion system of claim 4, wherein the one or more exhaust streams are warmed via indirect heat exchange with the flue gas exhaust stream.

20. The liquid air energy conversion system of claim 4, wherein the fuel source is natural gas or hydrogen or a mixture of hydrogen and natural gas.

21. A method of liquid air energy conversion comprising the steps of:
compressing a feed cryogenic gas stream to yield a low pressure cryogenic gas stream;
purifying the low pressure cryogenic gas stream to yield a pre-purified, low pressure cryogenic gas stream;
pumping the liquid air stream to a supercritical pressure yielding one or more supercritical liquid air streams;
vaporizing the one or more supercritical liquid air streams via indirect heat exchange against the purified, low pressure cryogenic gas stream to yield one or more very high pressure air streams and one or more cooled, purified, low pressure cryogenic gas streams;
compressing the one or more cooled, purified, low pressure cryogenic gas streams in one or more compressors, including at least one cold compressor to yield one or more moderate pressure, high pressure and/or very high pressure gas streams;
expanding a combustion gas in a combustion gas turbine to yield a flue gas exhaust stream and shaft work used to create a first source of electrical power;
warming all of or a portion of the one or more very high pressure air streams and/or all of or a portion of the one or more moderate pressure, high pressure or very high pressure gas streams to yield one or more warmed streams via indirect heat exchange with the flue gas exhaust stream; and
expanding the one or more of the warmed streams in one or more turbine-expanders to produce one or more exhaust streams and shaft work used to create one or more auxiliary sources of electrical power;
wherein the combustion gas is produced from the combustion of a fuel source with one or more originating from the deep sub-ambient gas compression subsystem.
